(19) United States
(12) Patent Application Publication
(10) Pub. No.: US 2002/0150700 A1
(43) Pub. Date: Oct. 17, 2002

(54) Utility box trim decor kit

(76) Inventor: Johnetta Tennie, Clinton Twp, MI (US)

Correspondence Address: Joseph N. Breaux, Suite A, 10630 N. Oak Hills Pkwy., Baton Rouge, LA, 70810, US

(21) Appl. No.: 10/098,257

(22) Filed: Mar. 14, 2002

Related U.S. Application Data
(60) Provisional application No. 60/283,198, filed on Apr. 11, 2001.

(51) Int. Cl. A01N 3/00

(52) U.S. Cl. 428/27

(57) ABSTRACT

A decorating system for decorating and/or covering the utility meters of a home such that the meters may still be read but which minimizes the aesthetic attraction caused by the industrial looking utility meters.

### TECHNICAL FIELD

The present invention relates to decorative home accessories and more particularly to a utility box decorating system that includes an ornamental box supported by spikes and easily snapped together to form an ornamental structure having a window through which a utility reader may read one or more meters monitoring utility service to a house such as water meters or electrical utility meters.

### BACKGROUND OF INVENTION

Utility meters such as water meters and electrical power meters often detract from the ornamental appearance of a home because of their industrial look clashes with the ornamental features of the home. It would be desirable, therefore, to have a decorator system for decorating and/or covering the utility meters in a manner such that they may still be accessed by the utility meter reader but which will provide an enhanced ornamental effect which will mask the existence of the utility meter with respect to the home.

### SUMMARY OF INVENTION

It is thus an object of the invention to provide a utility box trim decor kit that includes an ornamental box supported by spikes and easily snapped together to form an ornamental structure having a window through which a utility reader may read one or more meters monitoring utility service to a house such as water meters or electrical utility meters.

Accordingly, a utility box trim decor kit is provided. The utility box trim decor kit includes an ornamental box supported by spikes and easily snapped together to form an ornamental structure having a window through which a utility reader may read one or more meters monitoring utility service to a house such as water meters or electrical utility meters.

### BRIEF DESCRIPTION OF DRAWINGS

For a further understanding of the nature and objects of the present invention, reference should be had to the following detailed description, taken in conjunction with the accompanying drawings, in which like elements are given the same or analogous reference numbers and wherein:

FIG. 1 shows an exemplary embodiment of the utility box trim decor system of the present invention showing a snap together house structure having a window through which a utility meter reader may read the utility meters attached to a dwelling.

FIG. 2 shows the utility box trim decor system of FIG. 1 assembled and in use on a representative dwelling with the utility meters installed such that they are viewable through the meter reading window.

### EXEMPLARY EMBODIMENTS

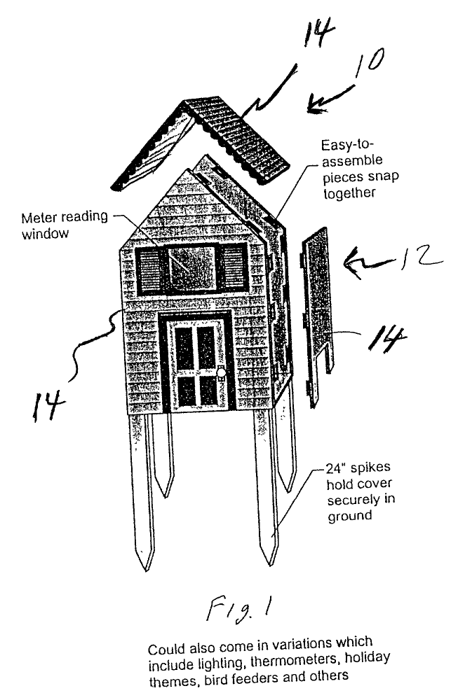

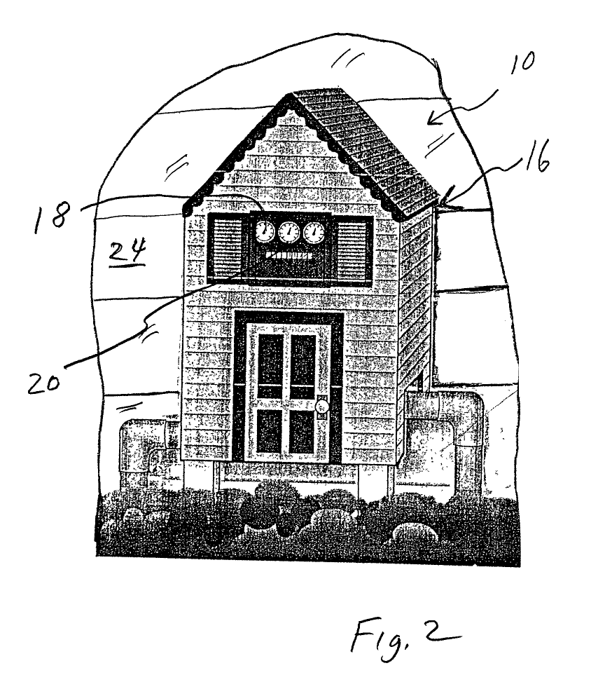

FIGS. 1 and 2 show various aspects of a utility box trim decor kit of the present invention generally designated 10. Utility box trim decor kit 10 includes an ornamental box system generally designated 12 including a number of user attachable parts 14 that form a enclosure structure 16 having a window 18 through which the meter reader or a utility meter reader may read the utility meters 20 of a house 24.

It can be seen from the preceding description that a utility box trim decor kit has been provided.

It is noted that the embodiment of the utility box trim decor kit described herein in detail for exemplary purposes is of course subject to many different variations in structure, design, application and methodology. Because many varying and different embodiments may be made within the scope of the inventive concept(s) herein taught, and because many modifications may be made in the embodiment herein detailed in accordance with the descriptive requirements of the law, it is to be understood that the details herein are to be interpreted as illustrative and not in a limiting sense.

What is claimed is:

1) A utility box trim decor kit comprising:
a number of snap together parts that form an ornamental box supported by spikes when snapped together;
the ornamental box having a window through which a utility meter positioned within the ornamental box may be read.
